(19) United States
(12) Patent Application Publication
(10) Pub. No.: US 2020/0283114 A1
(43) Pub. Date: Sep. 10, 2020

(54) MARINE MOTOR WITH A DUAL-FLOW EXHAUST GAS RECIRCULATION SYSTEM

(71) Applicant: COX POWERTRAIN LIMITED, Shoreham-By-Sea (GB)

(72) Inventor: Richard CORNWELL, Shoreham-By-Sea (GB)

(21) Appl. No.: 16/796,303

(22) Filed: Feb. 20, 2020

(30) Foreign Application Priority Data
Mar. 7, 2019 (GB) 1903078.2

(51) Int. Cl. B63H 20/24; F02D 41/00

(52) U.S. Cl. CPC B63H 20/24; F02B 3/06; F02D 41/0062

(57) ABSTRACT

A marine motor having an internal combustion engine having an engine block with at least one cylinder, an air intake, an exhaust conduit configured to direct a flow of exhaust gas from the at least one cylinder, and an exhaust gas recirculation system configured to recirculate a portion of the flow of exhaust gas from the exhaust conduit to the air intake. The exhaust gas recirculation system includes a first exhaust gas recirculation circuit with at least one first EGR cooler having a first overall conductance, and includes a second exhaust gas recirculation circuit with at least one second EGR cooler having a second overall conductance which is greater than the first overall conductance. The exhaust gas recirculation system also includes flow control means configured to selectively vary the relative proportions of first and second flows of recirculated exhaust gas through the first and second exhaust gas recirculation circuits to allow the amount of exhaust gas cooling to be varied.

### CROSS REFERENCE TO RELATED APPLICATIONS

This application claims priority to United Kingdom Patent Application No. 1903078.2, filed Mar. 7, 2019. The disclosure set forth in the referenced application is incorporated herein by reference in its entirety.

### TECHNICAL FIELD

The present invention relates to a marine motor having an internal combustion engine with an exhaust gas recirculation system configured to recirculate a portion of the flow of exhaust gas from an exhaust conduit to the air intake of the internal combustion engine. While this application relates to marine motors, the teachings may also be applicable to any other internal combustion engine.

### BACKGROUND

At present, the outboard engine market is dominated by petrol engines. Petrol engines are typically lighter than their diesel equivalents. However, a range of users, from military operators to super-yacht owners, have begun to favour diesel outboard motors because of the improved safety of diesel fuel, due to its lower volatility, and to allow fuel compatibility with the mother ship. Furthermore, diesel is a more economical fuel source with a more readily accessible infrastructure for marine applications.

To meet current emissions standards, modern diesel engines for automotive applications typically use sophisticated charge systems, such as direct cylinder injection and turbocharging, to improve power output and efficiency relative to naturally aspirated diesel engines. With direct injection, pressurised fuel is injected directly into the combustion chambers. This makes it possible to achieve more complete combustion resulting in better engine economy and emission control. Turbocharging is commonly known to produce higher power outputs, lower emission levels, and improved efficiency compared to normally aspirated diesel engines. In a turbocharged engine, pressurised intake air is introduced into the intake manifold to improve efficiency and power output by forcing extra amounts of air into the combustion chambers.

Modern diesel engines for automotive applications also typically employ exhaust gas recirculation (EGR) in order to reduce the gaseous emissions of oxides of nitrogen (NOx). NOx gases are produced from the reaction of nitrogen and oxygen during combustion, particular with high cylinder temperatures and pressures. In order to inhibit the generation of NOx gases, EGR systems redirect a portion of the exhaust gas back to the air intake of the engine to reduce the amount of oxygen supplied to the cylinders. The redirected exhaust gases are inert to combustion and act as absorbents of combustion heat. Consequently, the use of EGR can reduce peak temperatures and pressures in the cylinder and thereby reduce NOx emissions. Since exhaust gases are much hotter than ambient air, steps should be taken to ensure that the intake charge temperatures are not unduly increased by the inclusion of hot exhaust gases which might otherwise reduce charging efficiency and thus performance. In automotive EGR systems, an EGR cooler, in the form of a heat exchanger connected to a coolant circuit, is typically used to cool the recirculated exhaust gas prior to delivery to the air intake. While this is approach works well for automotive applications, it can be difficult to provide an effective EGR system which is well suited to marine applications. This is primarily because of the difference in typical duty cycle between automotive and marine engines, whereby the EGR system in a marine engine has to operate over a broad range of engine speeds and loading conditions, at least in part due to current emissions legislation. In addition, the exhaust gas recirculation flow requirements for a marine engine can differ significantly over a relatively small range of engine speeds, particularly when the engine is operating at and near to its rated power.

The present invention seeks to provide an improved marine motor which overcomes or mitigates one or more problems associated with the prior art.

### SUMMARY OF THE INVENTION

According to a first aspect of the present invention, there is provided a marine motor having an internal combustion engine, the internal combustion engine comprising: an engine block; at least one cylinder; an air intake configured to deliver a flow of air to the at least one cylinder; an exhaust conduit configured to direct a flow of exhaust gas from the at least one cylinder; and an exhaust gas recirculation system configured to recirculate a portion of the flow of exhaust gas from the exhaust conduit to the air intake, the exhaust gas recirculation system comprising: a first exhaust gas recirculation circuit comprising at least one first EGR cooler for cooling recirculated exhaust gas and having a first overall conductance; a second exhaust gas recirculation circuit comprising at least one second EGR cooler for cooling recirculated exhaust gas and having a second overall conductance which is greater than the first overall conductance; and flow control means configured to selectively vary the relative proportions of the first and second flows of recirculated exhaust gas which are directed through the first and second exhaust gas recirculation circuits. For example, according to an amount of exhaust gas cooling required.

With existing EGR systems, a single heat exchanger, or “EGR cooler”, is provided which must be appropriately configured, or “sized” for all EGR conditions. However, in marine applications, the EGR system has to operate over a broad range of engine speeds and loading conditions, at least in part due to current emissions legislation. This can be problematic, since a cooler which has sufficient heat rejection capacity to sufficiently cool a large amount of recirculated exhaust gas (for example 18 percent of the flow of exhaust gas) when the engine is operated at rated power will over-cool a lesser amount of recirculated exhaust gas (for example 5 percent of the flow of exhaust gas) when the engine is operated at a lower power. Conversely, a cooler which is sized so as not to over-cool recirculated exhaust gas when the engine is operated below rated power will not be able to sufficiently cool the recirculated exhaust gas when the engine is operated at its rated power. This can be exacerbated by the fact that the effectiveness of shell and tube or plate and fin type heat exchangers decreases as the exhaust gas flow rate through them increases. If the recirculated exhaust gas is over-cooled, this can lead to fouling of the heat exchanger and other components due to the formation of corrosive condensates from the exhaust gas. This can compromise engine durability and performance. If the recirculated exhaust gas is under-cooled, the temperature of intake charge will increase. This can reduce charging efficiency and engine performance and can increase peak pressure in the cylinder and NOx emissions. Where the engine employs one or more turbochargers, under-cooling of recirculated exhaust gas can also lead to excessive boost pressure requirements for the turbocharger.

With the claimed arrangement, the exhaust gas recirculation system is able to provide varying levels of recirculated exhaust gas cooling when the engine is operated under different operating conditions. In other words, the selective use of two different EGR circuits allows the cooling provided by the EGR system to be tailored to suit different engine operating conditions in which different amounts of heat rejection are required. This means that over-cooling at low EGR flow rates and under-cooling at high EGR flow rates can be avoided by appropriately sizing the first and second EGR coolers and selectively restricting the flow of recirculated exhaust gas through one or both of the first and second exhaust gas recirculation circuits.

The first overall conductance may be less than 80 percent of the second overall conductance. Preferably, the first overall conductance is less than 60 percent of the second overall conductance. More preferably, the first overall conductance is less than 50 percent of the second overall conductance. Most preferably, the first overall conductance is about one third of the second overall conductance.

The at least one first EGR cooler may comprise a plurality of discrete first EGR coolers which are spaced apart along the first exhaust gas recirculation circuit. Preferably, the at least one first EGR cooler is a single first EGR cooler. The at least one second EGR cooler may comprise a plurality of discrete second EGR coolers which are spaced apart along the second exhaust gas recirculation circuit. Preferably, the at least one second EGR cooler is a single second EGR cooler.

As used herein, the term “overall conductance” refers to the effectiveness of the at least one first EGR cooler and the at least one second EGR cooler in terms of the heat transfer rate “Q” per unit temperature difference. For an exhaust gas recirculation circuit having a single EGR cooler, this generally equates to the product of U·A, where “U” is the overall heat transfer coefficient of the heat exchanger and “A” is its effective heat transfer area. For an exhaust gas recirculation circuit having a plurality of heat exchangers, the overall conductance generally equates to the sum of the individual products of U·A of each heat exchanger, e.g. U₁·A₁+U₂·A₂.

The internal combustion engine may further comprise at least one turbocharger. In such embodiments, the first and second gas recirculation circuits may each extend from the exhaust conduit at a position upstream of the at least one turbocharger.

The flow control means may comprise any suitable mechanism. Preferably, the flow control means comprises at least one control valve configured to selectively restrict a flow of recirculated exhaust gas through one or both of the first and second exhaust gas recirculation circuits. The at least one control valve may be configured to selectively restrict the first flow of recirculated exhaust gas through the first exhaust gas recirculation circuit. The at least one control valve may be configured to selectively restrict the second flow of recirculated exhaust gas through the second exhaust gas recirculation circuit. The at least one control valve may be configured to selectively restrict the first flow of recirculated exhaust gas through the first exhaust gas recirculation circuit and the second flow of recirculated exhaust gas through the second exhaust gas recirculation circuit.

The at least one control valve preferably comprises at least one proportional valve. In other examples, the flow control means may comprise one or more flaps which may be selectively closed to prevent a flow of recirculated exhaust gas through one or both of the first and second exhaust gas recirculation circuits.

The at least one control valve preferably comprises a first control valve configured to selectively restrict a flow passage of the first exhaust gas recirculation circuit and a second control valve configured to selectively restrict a flow passage of the second exhaust gas recirculation circuit. This allows the flows of recirculated exhaust gas through the first and second exhaust gas recirculation circuits to be varied independently. The first and second control valves may be positioned at any suitable position along the first and second exhaust gas recirculation circuits. Preferably, the first and second control valves are located upstream of the at least one first and second EGR coolers, i.e. on the “hot side” of each exhaust gas recirculation circuit. In other examples, the at least one control valve may comprise a single control valve configured to selectively restrict a flow passage of each of the first and second exhaust gas recirculation circuits and/or to selectively direct a flow of exhaust gas between the first and second exhaust gas recirculation circuits.

The internal combustion engine may further comprise at least one sensor for generating an engine speed measurement and/or engine load measurement. In such embodiments, the flow control means preferably comprises a controller configured to determine a required total flow rate of recirculated exhaust gas through the first and second exhaust gas recirculation circuits based on the engine speed measurement and/or the engine load measurement and to operate the at least one control valve based on the required total flow rate. For example, the controller may be configured to calculate the required flow rate of recirculated exhaust has based on an engine speed measurement, or on an engine load measurement, or on both an engine speed measurement and an engine load measurement. In other examples, the at least one control valve may be operated from a control signal provided by a remote unit or operated automatically according to a predefined set of operating conditions, such as a look-up table containing data relating to the required total flow rate of recirculated exhaust gas against engine speed and engine load.

The controller is preferably configured to operate the at least one control valve such that, when the required total flow rate is below a first threshold, the first exhaust gas recirculation circuit is at least partially open and the second exhaust gas recirculation circuit is substantially closed and, when the total required flow rate is at or above a second threshold, both the first exhaust gas recirculation circuit and the second exhaust gas recirculation circuit are at least partially open. In such examples, the EGR system operates in a low flow, low cooling mode below the first threshold and a high flow, high cooling mode above the second threshold. The degree to which the at least one control valve opens the first and second exhaust gas recirculation circuits will depend on the required total flow rate of recirculated exhaust gas.

The first threshold may be substantially the same as the second threshold. In other examples, the first threshold may be below the second threshold.

The controller may be further configured to operate the at least one control valve such that, when the required total flow rate is at or above the first threshold and below the second threshold, the first exhaust gas recirculation circuit is substantially closed and the second exhaust gas recirculation circuit is at least partially open and, when the total required flow rate is at or above the second threshold, both of the first and second exhaust gas recirculation circuits are at least partially open. In such examples, the EGR system operates in a low cooling mode below the first threshold, in an intermediate cooling mode between the first and second thresholds, and in a high cooling mode above the second threshold.

The controller may be configured to determine, based on the engine speed measurement and/or the engine load measurement, a first required flow rate of recirculated exhaust gas through the first exhaust gas recirculation circuit and a second required flow rate of recirculated exhaust gas through the second exhaust gas recirculation circuit, and to operate the at least one control valve based on the first and second required flow rates.

Preferably, each EGR cooler forms part of a cooling circuit of the internal combustion engine, the cooling circuit having a plurality of coolant channels within the engine block for cooling the at least one cylinder. With this arrangement, it is not necessary for a separate EGR cooling circuit to be provided. This can reduce the weight of the EGR system and the space occupied by the EGR system in the cowl.

The cooling circuit may be configured such that the at least one first and second EGR coolers are downstream of the plurality of coolant channels within the engine block. In such an arrangement, the coolant first cools the at least one cylinder before moving along the cooling circuit to the at least one first and second EGR coolers to cool the recirculated exhaust gas. The at least one first and second EGR coolers may be arranged in parallel with one or more of the plurality of coolant channels within the engine block. The at least one first and second EGR coolers may be upstream of one or more of the plurality of coolant channels within the engine block and downstream of one or more of the plurality of coolant channels within the engine block.

The cooling circuit may be configured such that the at least one first and second EGR coolers of the EGR system are upstream of the plurality of coolant channels within the engine block. In such an arrangement, the coolant first enters the EGR cooler to cool the exhaust gas before moving along the plurality of coolant channels within the engine block to cool the at least one cylinder. This can provide particularly effective cooling of the exhaust gas.

The engine block may comprise a single cylinder. Preferably, the engine block comprises a plurality of cylinders.

As used herein, the term “engine block” refers to a solid structure in which at least one cylinder of the engine is provided. The term may refer to the combination of a cylinder block with a cylinder head and crankcase, or to the cylinder block only. The engine block may be formed from a single engine block casting. The engine block may be formed from a plurality of separate engine block castings which are connected together, for example using bolts.

The engine block may comprise a single cylinder bank.

The engine block may comprise a first cylinder bank and a second cylinder bank. The first and second cylinder banks may be arranged in a V configuration. The engine block may comprise three cylinder banks. The three cylinder banks may be arranged in a broad arrow configuration. The engine block may comprise four cylinder banks. The four cylinder banks may be arranged in a W or double-V configuration.

Where the engine block comprises a first cylinder bank and a second cylinder bank, the first exhaust gas recirculation circuit may be connected to a first exhaust conduit of the first cylinder bank and configured to recirculate a portion of the flow of exhaust gas from the first exhaust conduit to the air intake, and the second exhaust gas recirculation circuit may be connected to a second exhaust conduit of the second cylinder bank and configured to recirculate a portion of the flow of exhaust gas from the second exhaust conduit to the air intake. In this manner, the first exhaust gas recirculation circuit is associated with the first cylinder bank and the second exhaust gas recirculation circuit is associated with the second cylinder bank.

The internal combustion engine may be arranged in any suitable orientation. Preferably, the internal combustion engine is a vertical axis internal combustion engine. In such an engine, the internal combustion engine comprises a crankshaft which is mounted vertically in the engine.

The internal combustion engine may be a petrol engine.

Preferably, the internal combustion engine is a diesel engine. The internal combustion engine may be a turbocharged diesel engine.

The marine motor may be an inboard motor. Preferably, the marine motor is a marine outboard motor.

According to a second aspect of the present invention, there is provided a marine vessel comprising the marine motor of the first aspect.

According to a third aspect of the present invention, there is provided an internal combustion engine comprising: an engine block, at least one cylinder, an air intake configured to deliver a flow of air to the at least one cylinder, an exhaust conduit configured to direct a flow of exhaust gas from the at least one cylinder, and an exhaust gas recirculation system configured to recirculate a portion of the flow of exhaust gas from the exhaust conduit to the air intake, the exhaust gas recirculation system comprising: a first exhaust gas recirculation circuit comprising at least one first EGR cooler for cooling a first flow of recirculated exhaust gas and having a first overall conductance, a second exhaust gas recirculation circuit comprising at least one second EGR cooler for cooling a second flow of recirculated exhaust gas and having a second overall conductance which is greater than the first overall conductance, and flow control means configured to selectively vary the relative proportions of the first and second flows of recirculated exhaust gas through the first and second exhaust gas recirculation circuits. For example, according to an amount of exhaust gas cooling required.

Also disclosed is an exhaust gas recirculation system for an internal combustion engine having an engine block, at least one cylinder, an air intake configured to deliver a flow of air to the at least one cylinder, and an exhaust conduit configured to direct a flow of exhaust gas from the at least one cylinder, the exhaust gas recirculation system being configured to recirculate a portion of the flow of exhaust gas from the exhaust conduit to the air intake, the exhaust gas recirculation system comprising: a first exhaust gas recirculation circuit comprising at least one first EGR cooler for cooling a first flow of recirculated exhaust gas and having a first overall conductance; a second exhaust gas recirculation circuit comprising at least one second EGR cooler for cooling a second flow of recirculated exhaust gas and having a second overall conductance which is greater than the first overall conductance; and flow control means configured to selectively vary the relative proportions of the first and second flows of recirculated exhaust gas through the first and second exhaust gas recirculation circuits. For example, according to an amount of exhaust gas cooling required.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. In particular, features of the marine motor of the first aspect of the invention are equally applicable to the marine vessel of the second aspect of the invention and/or to the internal combustion engine of the third aspect of the invention. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Further features and advantages of the present invention will be further described below, by way of example only, with reference to the accompanying drawings in which:

FIG. 1 is a schematic side view of a light marine vessel provided with a marine outboard motor;

FIG. 2A shows a schematic representation of a marine outboard motor in its tilted position;

FIGS. 2B to 2D show various trimming positions of the marine outboard motor and the corresponding orientation of the marine vessel within a body of water;

FIG. 3 shows a schematic cross-section of a marine outboard motor according to a first embodiment of the present invention;

FIG. 4 shows a schematic illustration of the flow of intake air and exhaust gases to and from the internal combustion engine of the marine motor of FIG. 3;

FIG. 5 shows a schematic illustration of the flow of intake air and exhaust gases to and from the internal combustion engine of a marine motor according to a second embodiment of the invention.

### DETAILED DESCRIPTION

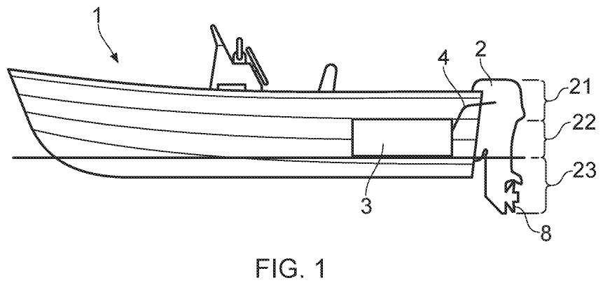

Referring firstly to FIG. 1, there is shown a schematic side view of a marine vessel 1 with a marine outboard motor 2. The marine vessel 1 may be any kind of vessel suitable for use with a marine outboard motor, such as a tender or a scuba-diving boat. The marine outboard motor 2 shown in FIG. 1 is attached to the stern of the vessel 1. The marine outboard motor 2 is connected to a fuel tank 3, usually received within the hull of the marine vessel 1. Fuel from the reservoir or tank 3 is provided to the marine outboard motor 2 via a fuel line 4. Fuel line 4 may be a representation for a collective arrangement of one or more filters, low pressure pumps and separator tanks (for preventing water from entering the marine outboard motor 2) arranged between the fuel tank 3 and the marine outboard motor 2.

As will be described in more detail below, the marine outboard motor 2 is generally divided into three sections, an upper-section 21, a mid-section 22, and a lower-section 23. The mid-section 22 and lower-section 23 are often collectively known as the leg section, and the leg houses the exhaust system. A propeller 8 is rotatably arranged on a propeller shaft at the lower-section 23, also known as the gearbox, of the marine outboard motor 2. Of course, in operation, the propeller 8 is at least partly submerged in water and may be operated at varying rotational speeds to propel the marine vessel 1.

Typically, the marine outboard motor 2 is pivotally connected to the stern of the marine vessel 1 by means of a pivot pin. Pivotal movement about the pivot pin enables the operator to tilt and trim the marine outboard motor 2 about a horizontal axis in a manner known in the art. Further, as is well known in the art, the marine outboard motor 2 is also pivotally mounted to the stern of the marine vessel 1 so as to be able to pivot, about a generally upright axis, to steer the marine vessel 1.

Tilting is a movement that raises the marine outboard motor 2 far enough so that the entire marine outboard motor 2 is able to be raised completely out of the water. Tilting the marine outboard motor 2 may be performed with the marine outboard motor 2 turned off or in neutral. However, in some instances, the marine outboard motor 2 may be configured to allow limited running of the marine outboard motor 2 in the tilt range so as to enable operation in shallow waters. Marine engine assemblies are therefore predominantly operated with a longitudinal axis of the leg in a substantially vertical direction. As such, a crankshaft of an engine of the marine outboard motor 2 which is substantially parallel to a longitudinal axis of the leg of the marine outboard motor 2 will be generally oriented in a vertical orientation during normal operation of the marine outboard motor 2, but may also be oriented in a non-vertical direction under certain operating conditions, in particular when operated on a vessel in shallow water. A crankshaft of a marine outboard motor 2 which is oriented substantially parallel to a longitudinal axis of the leg of the engine assembly can also be termed a vertical crankshaft arrangement. A crankshaft of a marine outboard motor 2 which is oriented substantially perpendicular to a longitudinal axis of the leg of the engine assembly can also be termed a horizontal crankshaft arrangement.

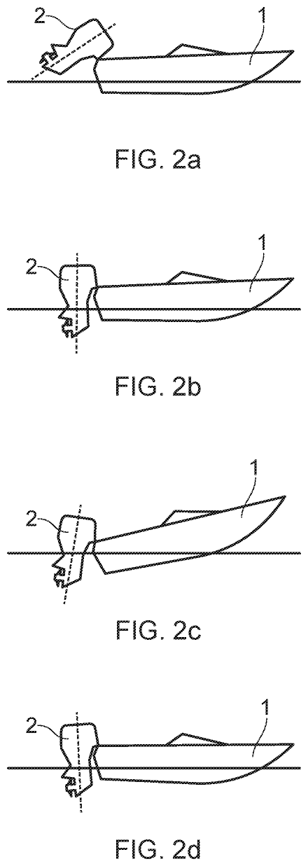

As mentioned previously, to work properly, the lower-section 23 of the marine outboard motor 2 needs to extend into the water. In extremely shallow waters, however, or when launching a vessel off a trailer, the lower-section 23 of the marine outboard motor 2 could drag on the seabed or boat ramp if in the tilted-down position. Tilting the marine outboard motor 2 into its tilted-up position, such as the position shown in FIG. 2A, prevents such damage to the lower-section 23 and the propeller 8.

By contrast, trimming is the mechanism that moves the marine outboard motor 2 over a smaller range from a fully-down position to a few degrees upwards, as shown in the three examples of FIGS. 2B to 2D. Trimming helps to direct the thrust of the propeller 8 in a direction that will provide the best combination of fuel efficiency, acceleration and high speed operation of the marine vessel 1.

When the vessel 1 is on a plane (i.e. when the weight of the vessel 1 is predominantly supported by hydrodynamic lift, rather than hydrostatic lift), a bow-up configuration results in less drag, greater stability and efficiency. This is generally the case when the keel line of the boat or marine vessel 1 is up about three to five degrees, such as shown in FIG. 2B for example.

Too much trim-out puts the bow of the vessel 1 too high in the water, such as the position shown in FIG. 2C. Performance and economy, in this configuration, are decreased because the hull of the vessel 1 is pushing the water and the result is more air drag. Excessive trimming-out can also cause the propeller to ventilate, resulting in further reduced performance. In even more severe cases, the vessel 1 may hop in the water, which could throw the operator and passengers overboard.

Trimming-in will cause the bow of the vessel 1 to be down, which will help accelerate from a standing start. Too much trim-in, shown in FIG. 2D, causes the vessel 1 to “plough” through the water, decreasing fuel economy and making it hard to increase speed. At high speeds, trimming-in may even result in instability of the vessel 1.

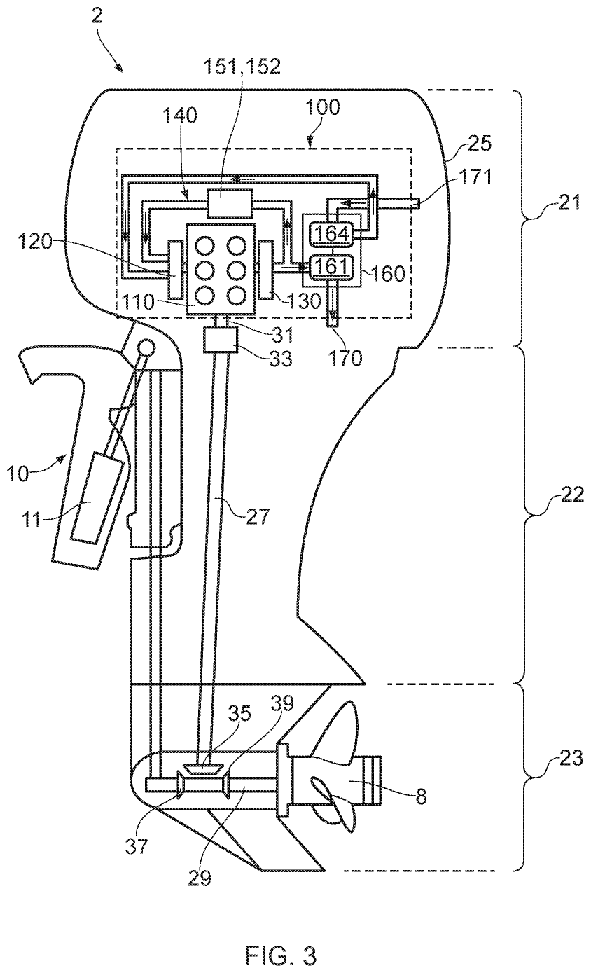

Turning to FIG. 3, there is shown a schematic cross-section of an outboard motor 2 according to an embodiment of the present invention. The outboard motor 2 comprises a tilt and trim mechanism 10 for performing the aforementioned tilting and trimming operations. In this embodiment, the tilt and trim mechanism 10 includes a hydraulic actuator 11 that can be operated to tilt and trim the outboard motor 2 via an electric control system. Alternatively, it is also feasible to provide a manual tilt and trim mechanism, in which the operator pivots the outboard motor 2 by hand rather than using a hydraulic actuator. As mentioned above, the outboard motor 2 is generally divided into three sections. An upper-section 21, also known as the powerhead, includes an internal combustion engine 100 for powering the marine vessel 1. A cowling 25 is disposed around the engine 100. Adjacent to, and extending below, the upper-section 21 or powerhead, there is provided a mid-section 22 and a lower section 23. The lower-section 23 extends adjacent to and below the mid-section 22, and the mid-section 22 connects the upper-section 21 to the lower-section 23. The mid-section 22 houses a drive shaft 27 which extends between the combustion engine 100 and the propeller shaft 29 and is connected to a crankshaft 31 of the combustion engine via a floating connector 33 (e.g. a splined connection). At the lower end of the drive shaft 27, a gear box/transmission is provided that supplies the rotational energy of the drive shaft 27 to the propeller 8 in a horizontal direction. In more detail, the bottom end of the drive shaft 27 may include a bevel gear 35 connected to a pair of bevel gears 37, 39 that are rotationally connected to the propeller shaft 29 of the propeller 8. The mid-section 22 and lower-section 23 form an exhaust system, which defines an exhaust gas flow path for transporting exhaust gases from an exhaust gas outlet 170 of the internal combustion engine 100 and out of the outboard motor 2.

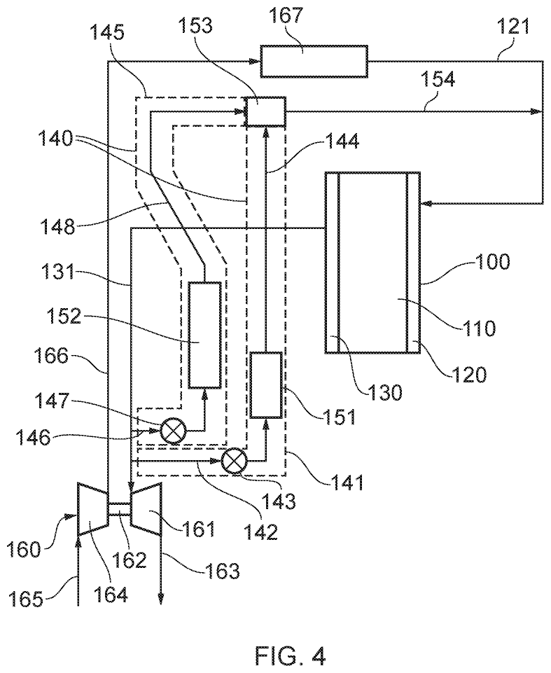

As shown schematically in FIG. 3, the internal combustion engine 100 includes an engine block 110, an air intake manifold 120 for delivering a flow of air to the cylinders in the engine block, and an exhaust manifold 130 configured to direct a flow of exhaust gas from the cylinders. The engine 100 further includes an exhaust gas recirculation (EGR) system 140 configured to recirculate a portion of the flow of exhaust gas from the exhaust manifold 130 to the air intake manifold 120. The EGR system includes a pair of heat exchangers 151, 152, or “EGR coolers”, for cooling recirculated exhaust gas, as discussed below with reference to FIG. 4. The internal combustion engine 100 is turbocharged and so further includes a turbocharger 160 connected to the exhaust manifold 130 and to the air intake manifold 120. In use, exhaust gases are expelled from each cylinder in the engine block 110 and are directed away from the engine block 110 by the exhaust manifold 130. Where exhaust gas recirculation is required, a portion of the exhaust gases are diverted to one or both of the heat exchangers 151, 152. The remaining exhaust gases are delivered from the exhaust manifold 130 to a turbine housing 161 of the turbocharger 160 where they are directed through the turbine before exiting the turbocharger 160 and the engine 100 via the engine exhaust outlet 170. The compressor housing 164 of the turbocharger, which is driven by the spinning turbine, draws in ambient air through an air intake 171 and delivers a flow of pressurised intake air to the air intake manifold 120. The engine 100 also includes an engine lubrication fluid circuit, to lubricate moving components in the engine block, and a turbocharger lubrication system (not shown in FIG. 3).

FIG. 4 shows a schematic illustration of the air flows to and from the internal combustion engine 100 according to a first embodiment of marine motor. With this first embodiment, the internal combustion engine 100 has an engine block 110 comprising a single cylinder bank to which the EGR system 140 and turbocharger 160 are connected. External to the engine block, an exhaust ducting arrangement is provided to direct exhaust gases away from the engine block 110 to the EGR system 140 and to the turbocharger 160. The exhaust ducting arrangement includes an exhaust manifold ducting 131 by which the exhaust manifold 130 is connected to the turbocharger 160. As shown, the turbine housing 161 and the compressor housing 164 are connected by a common shaft 162 by which the compressor wheel is driven by rotation of the turbine wheel. The turbine housing 161 is connected on its inlet side to the exhaust manifold ducting 131 and is connected on its outlet side to a turbocharger exhaust duct 163. The compressor housing 164 is connected on its inlet side to an air inlet duct 165 and is connected on its outlet side to a charge duct 166. As shown, the charge duct 166 extends between the compressor housing 164 and a charge air cooler 167 which is connected to the intake manifold 120 by an intake conduit 121. Following combustion in the cylinders within the engine block 110, exhaust gases pass to the exhaust manifold 130 and are delivered to the turbine housing 161 of the turbocharger 160 via the exhaust manifold ducting 131. The exhaust gases spin the turbine to drive the compressor before flowing out of the turbine housing 161 via the turbocharger exhaust duct 163.

The EGR system 140 includes a first exhaust gas recirculation circuit 141 having a first EGR hot exhaust duct 142, a first control valve 143, a first EGR cooler 151 and a first EGR cooled exhaust duct 144. The first EGR hot exhaust duct 142 is branched off from the exhaust manifold ducting 131 at a location upstream of the turbocharger 160 and extends to an upstream end of the first EGR cooler 151. The EGR system 140 also includes a second exhaust gas recirculation circuit 145 having a second EGR hot exhaust duct 146, a second control valve 147, a second EGR cooler 152 and a second EGR cooled exhaust duct 148. The second EGR hot exhaust duct 146 is branched off from the exhaust manifold ducting 131 at a location upstream of the turbocharger 160 and extends to an upstream end of the second EGR cooler 152. Each of the first and second EGR cooled exhaust ducts 144, 148 extend from the downstream end of their respective EGR cooler 151, 152 to an EGR mixer 153. The EGR mixer 153 is connected to the intake manifold 120 via a mixed EGR exhaust duct 154 which extends from the EGR mixer 153 to the intake conduit 121.

The first and second heat exchangers each include one or more coolant channels and one or more exhaust gas channels which are in thermal contact but which prevent fluid contact between coolant and exhaust gases. During use, coolant fluid, which is typically water drawn from a body of water in which the marine motor is used, is pumped into the coolant channels and through each heat exchanger to cool any exhaust gases flowing through the exhaust gas channels in the heat exchangers. The EGR coolers may be connected to their own coolant circuit or circuits. Preferably, the first and second EGR coolers 151, 152 form part of a cooling circuit (not shown) of the internal combustion engine, the cooling circuit having a plurality of coolant channels (not shown) within the engine block for cooling the at least one cylinder. For example, the first and second EGR coolers 151, 152 may be upstream of the engine block so that coolant first passes through the EGR coolers before passing through the coolant channels within the engine block.

The first heat exchanger 151 has a first overall conductance which defines the ability of the first heat exchanger 151 to draw heat away from exhaust gases flowing along the first exhaust gas circulation circuit 141. Similarly, the second heat exchanger 152 has a second overall conductance which defines the ability of the second heat exchanger 152 to draw heat away from exhaust gases flowing along the second exhaust gas circulation circuit 145. As illustrated in FIG. 4 by the relative sizes of the first and second heat exchangers, the first overall conductance is less than the second overall conductance. In practical terms, this means that the second heat exchanger 152 is able to draw more heat away from a flow of exhaust gas than the first heat exchanger 151 for a given exhaust flow rate and temperature. In this manner, the second exhaust gas circulation circuit can be considered as a high heat rejection (“high HR”) circuit and the first exhaust gas circulation circuit can be considered as a low heat rejection (“low HR”) circuit. For example, the first overall conductance may be less than 80 percent of the second overall conductance, less than 60 percent of the second overall conductance, or less than 50 percent of the second overall conductance. In this example, the first overall conductance is about 33% of the second overall conductance.

The first control valve 143 and the second control valve 147 selectively restrict the first and second EGR hot exhaust ducts 142, 146 to selectively restrict a flow of recirculated exhaust gas through each of the first and second exhaust gas recirculation circuits 141, 145 and thereby regulate the amount of hot exhaust gas diverted from the exhaust manifold ducting 131 to the EGR coolers 151, 152. The first and second control valves 143, 147 are connected to a controller (not shown) which is configured to determine a required total flow rate of recirculated exhaust gas through the first and second exhaust gas recirculation circuits and to operate the first and second control valves 143, 147 based on the required total flow rate. In particular, the controller is configured to operate the first and second control valves 143, 147 such that, when the required total flow rate is below a first threshold, the first control valve 143 is at least partially open and the second control valve 147 is substantially closed and, when the total required flow rate is at or above a second threshold, both the first and second control valves 143, 147 are at least partially open. In practical terms, this means that the second (high HR) exhaust gas recirculation circuit is closed when the required total flow rate is below the first threshold but that both circuits are open when the required total flow rate is above the second threshold. The controller may also be configured to operate the first and second control valves 143, 147 such that when the required total flow rate is between the first and second thresholds, the second control valve 147 is at least partially open and the first control valve 143 is substantially closed. Thus, between the first and second thresholds, the second (high HR) exhaust gas recirculation circuit is open and the first (low HR) circuit is closed. With this arrangement, the EGR system operates in a low cooling mode under low EGR flow conditions below the first threshold (e.g. EPA T3 full load with 5% EGR), in an intermediate cooling mode between the first and second thresholds, and in a high cooling mode under high EGR flow conditions (e.g. IMO T3 rated power with 18% EGR) above the second threshold. In this manner, the first and second control valves 143, 147 and the controller together act as flow control means to regulate the relative proportions of the first and second flows of recirculated exhaust gas through the first and second exhaust gas recirculation circuits and thereby regulate the amount of recirculated exhaust gas and the degree to which EGR cooling occurs.

As will be understood, the EGR system may also be operated in a no cooling mode, in which both of the first and second control valves 143, 147 are substantially closed, when little or no exhaust gas recirculation is required.

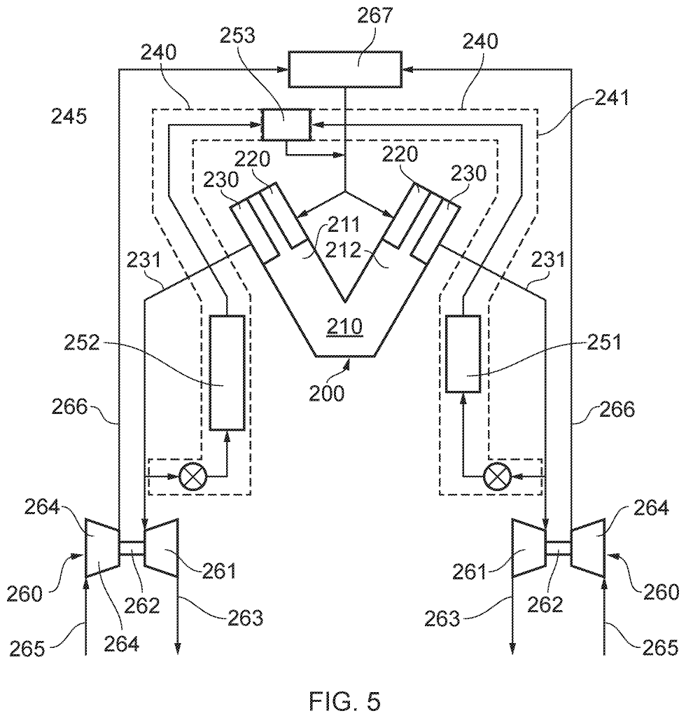

FIG. 5 shows a schematic illustration of the air flows to and from the internal combustion engine 200 according to a second embodiment of marine motor. The second embodiment has a similar structure and operation to the first embodiment discussed above in relation to FIG. 4 and similar reference numerals are used to denote similar features. In this embodiment, the engine block 210 comprises first and second cylinder banks 211, 212 arranged in a V configuration and each housing a plurality of cylinders and movable pistons forming combustion chambers within the engine block. Each cylinder bank has its own intake manifold 220, exhaust manifold 230, and turbocharger 260. It will be understood that any other amount of cylinders may be employed in the V-shaped cylinder banks. It will also be understood that any other arrangement, such as an in-line arrangement, could alternatively be utilised. In this embodiment, each of the first and second exhaust gas circulation circuits 241, 245 is connected to one of the two cylinder banks 211, 212 so that the first and second heat exchangers 251, 252 act as dedicated coolers for each cylinder bank.

The exhaust ducting arrangement includes a first exhaust manifold ducting 231 by which the first exhaust manifold 230 of the first cylinder bank 211 is connected to the first turbocharger 260, and a second exhaust manifold ducting 231 by which the second exhaust manifold 230 of the second cylinder bank 212 is connected to the second turbocharger 260. The compressor housing 264 of the first turbocharger is connected on its inlet side to a first air inlet duct 265 and is connected on its outlet side to a first charge duct 266. Similarly, the compressor housing 264 of the second turbocharger 260 is connected on its inlet side to a second air inlet duct 265 and is connected on its outlet side to a second charge duct 266. In each case, the charge duct 266 extends between the compressor housing 264 and a charge air cooler 267 which is connected to the intake manifold 220 of each cylinder bank by an intake conduit 221.

As with the EGR system of the first embodiment, the EGR system 240 of the second embodiment includes a first exhaust gas recirculation circuit 241 having a first EGR cooler 251 with a first overall conductance, and includes a second exhaust gas recirculation circuit 245 having a second EGR cooler 252 with a second overall conductance which is greater than the first overall conductance. The first exhaust gas recirculation circuit 241 extends between the first exhaust manifold ducting 231 from the first cylinder bank 211 and the EGR mixer 253, while the second exhaust gas recirculation circuit 245 extends between the second exhaust manifold ducting 231 from the second cylinder bank 212 and the EGR mixer 253. Downstream of the EGR mixer 253, the mixed flow of EGR gases is combined with charge air from the charge air cooler 267 and fed to the intake manifold 220 of each cylinder bank.

With the claimed arrangement, the exhaust gas recirculation system is able to provide varying levels of recirculated exhaust gas cooling when the engine is operated under different operating conditions. In other words, the selective use of two different EGR circuits allows the cooling provided by the EGR system to be tailored to suit different engine operating conditions in which different amounts of heat rejection are required. This means that over-cooling at low EGR flow rates and under-cooling at high EGR flow rates can be avoided by appropriately sizing the first and second heat exchangers and selectively restricting the flow of recirculated exhaust gas through one or both of the first and second exhaust gas recirculation circuits as required.

Although the invention has been described above with reference to one or more preferred embodiments, it will be appreciated that various changes or modifications may be made without departing from the scope of the invention as defined in the appended claims.

For example, although each of the first and second exhaust gas recirculation circuits is shown as having a single EGR cooler, in practice, one or both circuits may have any number of EGR coolers which together contribute to the overall conductance of that circuit. By way of example, the greater second conductance could be achieved by using two EGR coolers in series, or in parallel, for the second exhaust gas recirculation circuit and using only a single EGR cooler for the first exhaust gas recirculation circuit. The EGR coolers may have the same configuration as each other and this may also be the same configuration as the single EGR cooler of the first circuit.

1-16. (canceled)

17. A marine motor having an internal combustion engine, the internal combustion engine comprising:
an engine block;
at least one cylinder;
an air intake configured to deliver a flow of air to the at least one cylinder;
an exhaust conduit configured to direct a flow of exhaust gas from the at least one cylinder; and
an exhaust gas recirculation system configured to recirculate a portion of the flow of exhaust gas from the exhaust conduit to the air intake, the exhaust gas recirculation system comprising:
a first exhaust gas recirculation circuit comprising at least one first EGR cooler for cooling a first flow of recirculated exhaust gas and having a first overall conductance;
a second exhaust gas recirculation circuit comprising at least one second EGR cooler for cooling a second flow of recirculated exhaust gas and having a second overall conductance which is greater than the first overall conductance; and
flow control means configured to selectively vary the relative proportions of the first and second flows of recirculated exhaust gas through the first and second exhaust gas recirculation circuits.

18. The marine motor of claim 17, wherein the first overall conductance is less than 80 percent of the second overall conductance.

19. The marine motor of claim 17, wherein the first overall conductance is less than 60 percent of the second overall conductance.

20. The marine motor claim 17, wherein the first overall conductance is less than 50 percent of the second overall conductance.

21. The marine motor of claim 17, wherein the internal combustion engine further comprises at least one turbocharger, and wherein the first and second exhaust gas recirculation circuits each extend from the exhaust conduit at a position upstream of the at least one turbocharger.

22. The marine motor of claim 17, wherein the flow control means comprises at least one control valve configured to selectively restrict a flow of recirculated exhaust gas through one or both of the first and second exhaust gas recirculation circuits.

23. The marine motor of claim 22, wherein the at least one control valve comprises a first control valve configured to selectively restrict a flow passage of the first exhaust gas recirculation circuit and a second control valve configured to selectively restrict a flow passage of the second exhaust gas recirculation circuit.

24. The marine motor of claim 22, wherein the internal combustion engine further comprises at least one sensor for generating an engine speed measurement and/or engine load measurement, and wherein the flow control means comprises a controller configured to determine a required total flow rate of recirculated exhaust gas through the first and second exhaust gas recirculation circuits based on the engine speed measurement and/or the engine load measurement and to operate the at least one control valve based on the required total flow rate.

25. The marine motor of claim 24, wherein the controller is configured to operate the at least one control valve to at least partially open the first exhaust gas recirculation circuit and substantially close the second exhaust gas recirculation circuit when the required total flow rate is below a first threshold, and to at least partially open both the first exhaust gas recirculation circuit and the second exhaust gas recirculation when the total required flow rate is at or above a second threshold.

26. The marine motor of claim 25, wherein the controller is configured to operate the at least one control valve to substantially close the first exhaust gas recirculation circuit and at least partially open the second exhaust gas recirculation circuit when the required total flow rate is at or above the first threshold and below the second threshold, and to at least partially open both of the first and second exhaust gas recirculation circuits when the total required flow rate is at or above the second threshold.

27. The marine motor of claim 24, wherein the controller is configured to determine a first required flow rate of recirculated exhaust gas through the first exhaust gas recirculation circuit and a second required flow rate of recirculated exhaust gas through the second exhaust gas recirculation circuit based on the engine speed measurement and/or the engine load measurement, and to operate the at least one control valve based on the first and second required flow rates.

28. The marine motor of claim 17, wherein the at least one first EGR cooler and the at least one second EGR cooler form part of a cooling circuit of the internal combustion engine, the cooling circuit having a plurality of coolant channels within the engine block for cooling the at least one cylinder.

29. The marine motor of claim 28, wherein the cooling circuit is configured such that the at least one first EGR cooler and the at least one second EGR cooler are upstream of the plurality of coolant channels.

30. The marine motor of claim 17, wherein the engine block comprises a first cylinder bank and a second cylinder bank

31. The marine motor of claim 30, wherein the first exhaust gas recirculation circuit is connected to a first exhaust conduit of the first cylinder bank and configured to recirculate a portion of the flow of exhaust gas from the first exhaust conduit to the air intake, and the second exhaust gas recirculation circuit is connected to a second exhaust conduit of the second cylinder bank and configured to recirculate a portion of the flow of exhaust gas from the second exhaust conduit to the air intake.

32. The marine motor of claim 17, wherein the internal combustion engine is a turbocharged diesel engine.

33. The marine motor of claim 17, wherein the marine motor is a marine outboard motor.

34. A marine vessel comprising the marine motor of claim 17.

35. An internal combustion engine comprising:
an engine block;
at least one cylinder;
an air intake configured to deliver a flow of air to the at least one cylinder;
an exhaust conduit configured to direct a flow of exhaust gas from the at least one cylinder; and
an exhaust gas recirculation system configured to recirculate a portion of the flow of exhaust gas from the exhaust conduit to the air intake, the exhaust gas recirculation system comprising:
a first exhaust gas recirculation circuit comprising at least one first EGR cooler for cooling a first flow of recirculated exhaust gas and having a first overall conductance;
a second exhaust gas recirculation circuit comprising at least one second EGR cooler for cooling a second flow of recirculated exhaust gas and having a second overall conductance which is greater than the first overall conductance; and
flow control means configured to selectively vary the relative proportions of the first and second flows of recirculated exhaust gas through the first and second exhaust gas recirculation circuits.
